(19) United States
(12) Patent Application Publication
(10) Pub. No.: US 2025/0356360 A1
(43) Pub. Date: Nov. 20, 2025

(54) Technologies for Providing Self-Updating Alert Volume Prediction

(71) Applicant: The PNC Financial Services Group, Inc., Pittsburgh, PA (US)

(72) Inventors: Kaushik Sirvole, Houston, TX (US); Jayanthi Annasamudram, McDonald, PA (US); Amanda McCracken, Westerville, OH (US)

(21) Appl. No.: 19/196,366

(22) Filed: May 1, 2025

Related U.S. Application Data
(60) Provisional application No. 63/647,663, filed on May 15, 2024.

(51) Int. Cl. G06Q 20/40; G06Q 10/04

(52) U.S. Cl. CPC G06Q 20/4016; G06Q 10/04

(57) ABSTRACT

Technologies for providing self-updating alert volume prediction include a compute device. The compute device may include circuitry configured to obtain historical alert data indicative of alerts produced by each of multiple money laundering scenario detection models associated with deposit accounts. Further, the circuitry may be configured to train, prior to producing a prediction, at least one alert volume prediction model with the obtained historical alert data. In addition, the circuitry may be configured to predict, with the at least one alert volume prediction model, a number of alerts to be generated by the money laundering scenario detection models over a future time period.

### RELATED APPLICATIONS

This application claims the benefit U.S. Provisional Application No. 63/647,663 filed May 15, 2024 for “Technologies for Providing Self-Updating Alert Volume Prediction,” which is hereby incorporated by reference in its entirety.

### BACKGROUND

Financial institutions, such as banks, are required to comply with regulations relating to reporting suspected money laundering. Due at least in part to the growing digitization of banking, new channels have emerged through which financial transactions may occur. Correspondingly, the number of ways in which money laundering may take place has also increased. As such, detecting and reporting on suspected money laundering can be a significant expense for a financial institution, in terms of time, financial resources, technological resources, and personnel dedicated to reviewing transactions and preparing government-mandated reports of suspected financial crime.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for continually predicting a volume of alerts for potential money laundering scenarios;

FIG. 2 is a simplified block diagram of at least one embodiment of a compute device of the system of FIG. 1;

FIGS. 3-6 are simplified block diagrams of at least one embodiment of a method for predicting a volume of alerts for potential money laundering scenarios that may be executed by the system of FIG. 1;

FIG. 7 is a diagram of at least one embodiment of a process for preparing data and training one or more alert volume prediction models that may be utilized by the system of FIG. 1;

FIG. 8 is a diagram of an allocation of significance to features that may be utilized in one or more alert volume prediction models of the system of FIG. 1;

FIG. 9 is a diagram of at least one embodiment of a process for training and using one or more alert volume prediction models that may be utilized by the system of FIG. 1; and

FIG. 10 is a diagram of at least one embodiment of an allocation of historical data that may be utilized by the system of FIG. 1 for training, validating, and testing one or more models for predicting alert volume.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

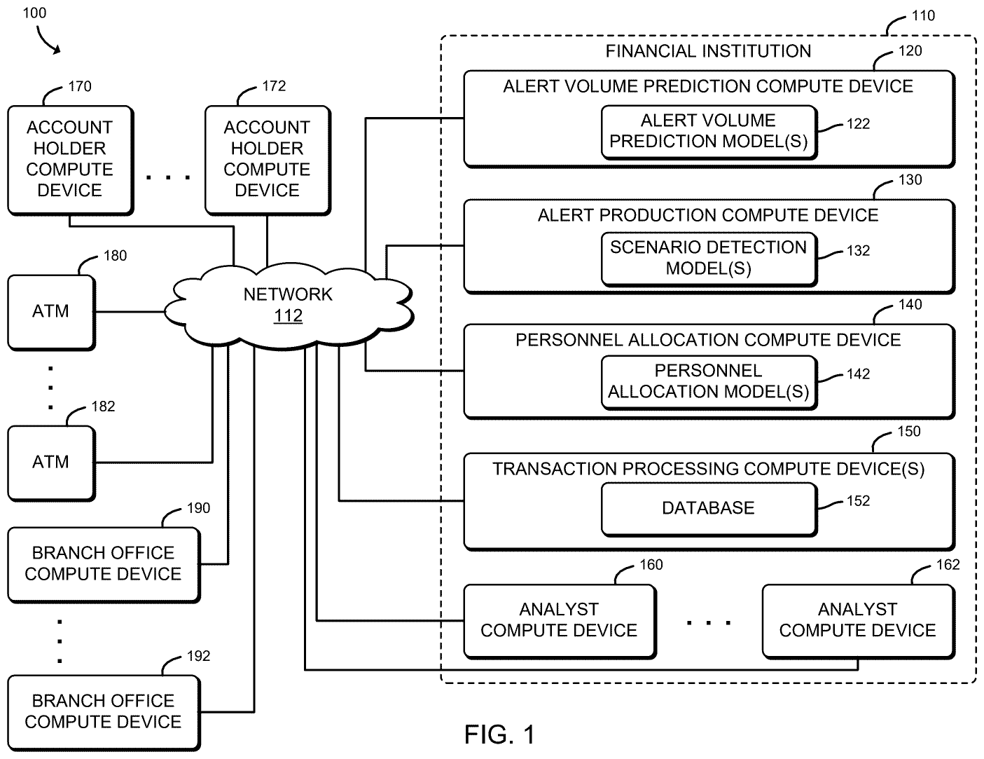

Referring now to FIG. 1, a system 100 for continually predicting a volume of alerts for potential money laundering scenarios includes, in the illustrative embodiment, an alert volume prediction compute device 120 communicatively coupled to other compute devices 130, 140, 150, 160, 162 of a financial institution 110. In the illustrative embodiment, one or more transaction processing compute devices 150 process financial transactions, update associated balances of the financial accounts (e.g., deposit accounts), and store a record of the financial transactions in a database 152 (e.g., a system of record). Those transactions may be initiated by customers (e.g., account holders) of the financial institution 110 via account holder compute devices 170, 172 (e.g., laptops, smart phones, etc. of the account holders), automated teller machines (ATMs) 180, 182, branch office compute devices 190, 194, and/or other devices. In operation, the alert production compute device 130 may utilize a set of scenario detection models 132 to analyze records of financial transactions 152 to identify scenarios (e.g., patterns of financial transactions) that are indicative of potential money laundering. In response to a determination that a given money laundering scenario may be present, the alert production compute device 130 may produce a corresponding alert to be routed to an analyst compute device 160, 162 (e.g., operated by a person assigned to a financial crime analysis team) for further research to confirm whether the underlying financial transaction(s) are indeed indicative of potential money laundering and to prepare a suspicious activity report (SAR) or similar report for review by a government organization in accordance with banking regulations.

Due to ongoing changes in the banking system, the scenario detection models 132 may be adapted over time to account for new channels or methodologies by which criminals may launder money. Further, opportunities for certain forms of money laundering may become more available or less available depending on the time of year (e.g., tax season, certain holidays, etc.). As such, the number of alerts produced by the scenario detection models 132 may vary significantly over a given time period (e.g., 12 months). In operation, the alert volume prediction compute device 120 repeatedly (e.g., on a repeated basis, such as once per week) trains and utilizes a set of one or more alert volume prediction models 122 to analyze the alerts produced by the alert production compute device 130 (based on the underlying scenario detection models 132) and the underlying financial transaction data, and predict the number of alerts that will be produced during each subset (e.g., each week) of a longer time period (e.g., a year). That is, in producing the predictions, the alert volume prediction compute device 120 retrains the alert volume prediction model(s) 122 repeatedly (e.g., on a weekly basis) to adapt to changes in the banking system, new methodologies for performing money laundering, and corresponding changes to the scenario detection models 132.

Further, the alert volume prediction compute device 120 may provide the alert volume predictions to a personnel allocation compute device 140, which may execute one or more personnel allocation models 142 to determine a number of personnel that should be allocated to the team to research the alerts, determine whether scenarios indicative of money laundering are indeed present, and prepare corresponding suspicious activity reports (SARs). As such, unlike conventional systems in which a financial institution may keep a set number of people within a research team based on a general average number of alerts that the financial institution expects over a year or more, the system 100 enables the financial institution to efficiently allocate resources to the task of reviewing the alerts and filing suspicious activity reports (SARs) on a much more detailed schedule (e.g., week by week), thereby reducing over-allocation of resources in times when fewer SARs will be prepared and providing sufficient resources when more SARs are likely to be prepared.

While twelve compute devices 120, 130, 140, 150, 160, 162, 170, 172, 180, 182, 190, 192 are shown in FIG. 1 for simplicity and clarity, it should be understood that the number of compute devices, in practice, may range in the tens, hundreds, thousands, or more. Likewise, it should be understood that the compute devices 120, 130, 140, 150, 160, 162, 170, 172, 180, 182, 190, 192 may be distributed differently or perform different roles than the configuration shown in FIG. 1. Further, though shown as separate compute devices 120, 130, 140, 150, 160, 162, 170, 172, 180, 182, 190, 192 in some embodiments, the functionality of one or more of the compute devices 120, 130, 140, 150, 160, 162, 170, 172, 180, 182, 190, 192 may be combined into fewer compute devices (the alert volume prediction compute device 120 may be combined with the alert production compute device 130, the personnel allocation compute device 140, and/or the transaction processing compute device(s) 150) and/or distributed across more compute devices than those shown in FIG. 1 (e.g., the alert volume prediction compute device 120 may comprise multiple compute devices).

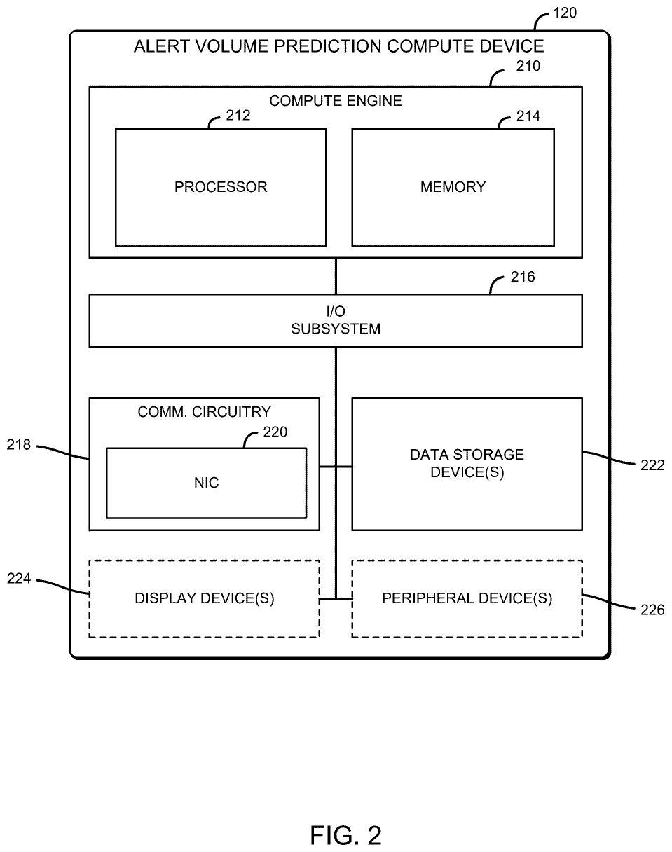

Referring now to FIG. 2, the illustrative alert volume prediction compute device 120 includes a compute engine 210, an input/output (I/O) subsystem 216, communication circuitry 218, and one or more data storage devices 222. In some embodiments, the alert volume prediction compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the alert volume prediction compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as historical alert data, historical financial transaction data, alert volume prediction model(s), applications, libraries, and drivers.

The compute engine 210 is communicatively coupled to other components of the alert volume prediction compute device 120 via the I/O subsystem 216, which may be embodied as circuitry and/or components to facilitate input/output operations with the compute engine 210 (e.g., with the processor 212 and the main memory 214) and other components of the alert volume prediction compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the alert volume prediction compute device 120, into the compute engine 210.

The communication circuitry 218 may be embodied as any communication circuit, device, or collection thereof, capable of enabling communications over a network between the alert volume prediction compute device 120 and another device (e.g., a compute device 130, 140, 150, 160, 162, 170, 172, 180, 182, 190, 192, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the alert volume prediction compute device 120 to connect with another compute device (e.g., a compute device 130, 140, 150, 160, 162, 170, 172, 180, 182, 190, 192, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the alert volume prediction compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the alert volume prediction compute device 120 are housed in a single unit. However, in other embodiments, the components may be in separate housings, in separate racks of a data center, and/or spread across multiple data centers or other facilities. The compute devices 130, 140, 150, 160, 162, 170, 172, 180, 182, 190, 192 may have components similar to those described in FIG. 2 with reference to the alert volume prediction compute device 120. The description of those components of the alert volume prediction compute device 120 is equally applicable to the description of components of the compute devices 130, 140, 150, 160, 162, 170, 172, 180, 182, 190, 192. Further, it should be appreciated that any of the devices 120, 130, 140, 150, 160, 162, 170, 172, 180, 182, 190, 192 may include other components, sub-components, and devices commonly found in a computing device, which are not discussed above in reference to the alert volume prediction compute device 120 and not discussed herein for clarity of the description.

In the illustrative embodiment, the compute devices 120, 130, 140, 150, 160, 162, 170, 172, 180, 182, 190, 192 are in communication via a network 112, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

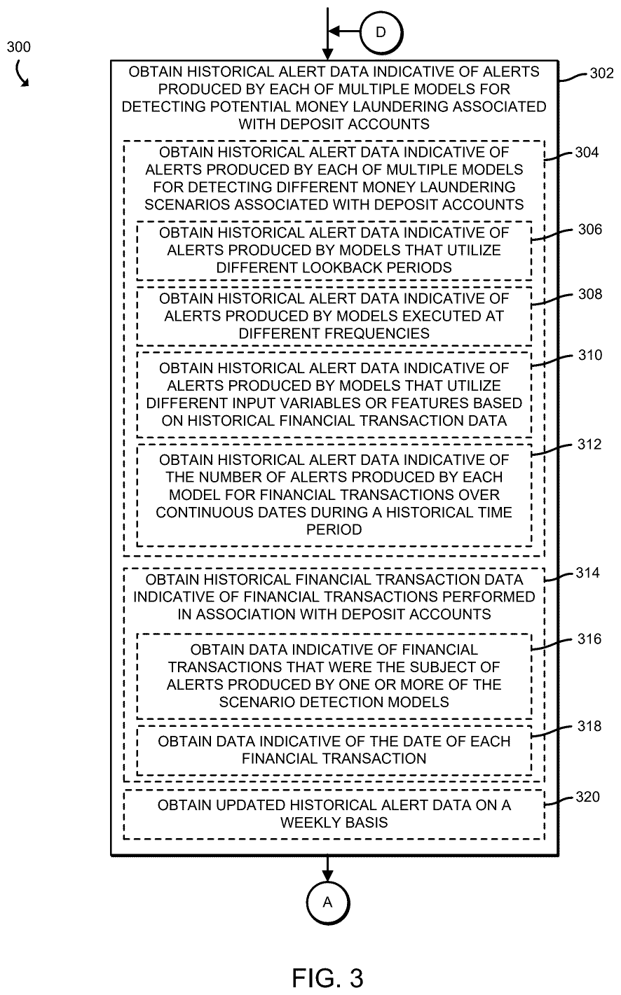

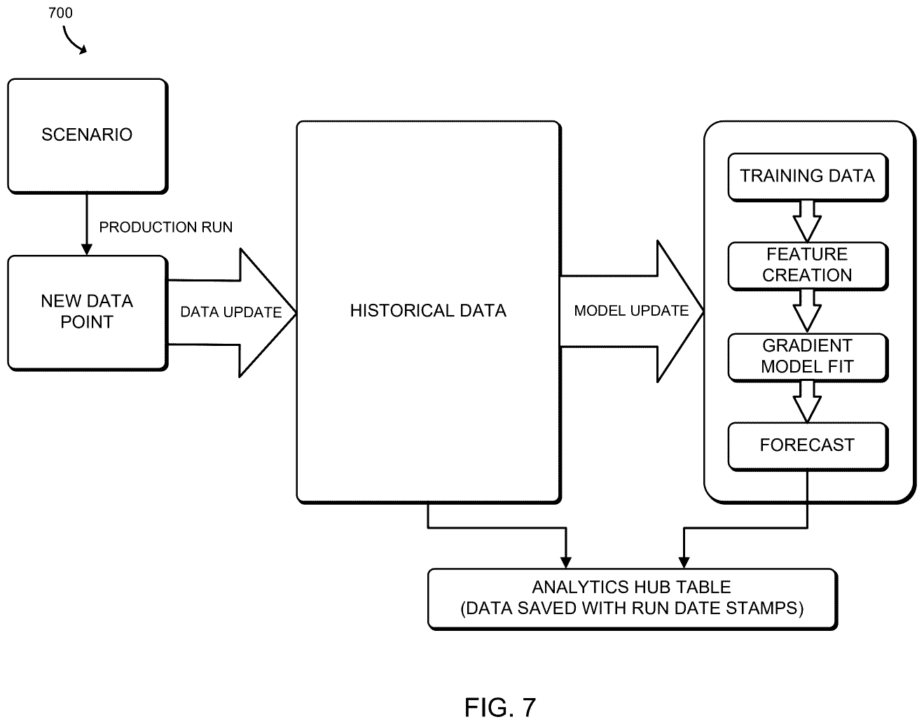

Referring now to FIG. 3, the system 100, and specifically, the alert volume prediction compute device 120, in the illustrative embodiment, may perform a method 300 for predicting a volume of alerts for potential money laundering scenarios, to enable the financial institution 110 to precisely allocate personnel to a team to review the alerts and potentially file corresponding reports to a government agency. A high level diagram 700 of the operations is provided in FIG. 7. The method 300 begins with block 302 in which the alert volume prediction compute device 120 obtains historical alert data indicative of alerts produced by each of multiple models (e.g., the scenario detection models 132) for detecting potential money laundering associated with deposit accounts (e.g., deposit accounts of customers of the financial institution 110). In some embodiments, the alert volume prediction compute device 120 may obtain the historical alert data in response to a request to the alert production compute device 130, which may store a record of each alert in a corresponding database. In other embodiments, the alert volume prediction compute device 120 may obtain the historical alert data from another source (e.g., another compute device 120, 130, 140, 150, 160, 162 of the system 100). Regardless, in obtaining the historical alert data, the alert volume prediction compute device 120, in the illustrative embodiment, obtains historical alert data indicative of alerts that were produced by each of multiple models for detecting different money laundering scenarios associated with deposit accounts, as indicated in block 304. That is, the scenario detection models 132 may be configured to detect different money laundering scenarios (e.g., one per model), rather than a single type of money laundering.

As indicated in block 306, the alert volume prediction compute device 120 may obtain historical alert data that is indicative of alerts produced by models that utilize different lookback periods (e.g., historical periods of time under analysis), such as one week, two weeks, three weeks, four weeks, or monthly. Relatedly, the alert volume prediction compute device 120 may obtain historical alert data indicative of alerts produced by models that are executed (e.g., by the alert production compute device 130) at different frequencies (e.g., weekly, bi-weekly, tri-weekly, every four weeks, monthly, etc.), as indicated in block 308. The alert volume prediction compute device 120 may obtain historical alert data indicative of alerts produced by models (e.g., the scenario detection models 132) that utilize different input variables or features (e.g., combinations of variables or data produced therefrom) from each other (e.g., to detect different scenarios) based on historical financial transaction data, as indicated in block 310. In the illustrative embodiment, the alert volume prediction compute device 120 obtains historical alert data indicative of the number of alerts produced by each model for financial transactions recorded over continuous dates during a historical time period (e.g., a year or more), as indicated in block 312. That is, in the illustrative embodiment, the alert volume prediction compute device 120 obtains historical alert data in which there are no unaccounted-for dates in the historical time period.

As indicated in block 314, the alert volume prediction compute device 120 may obtain historical financial transaction data indicative of financial transactions performed in association with the deposit accounts (e.g., the financial transactions processed by the transaction processing compute device 150 and analyzed by the alert production compute device 130 with the scenario detection models 132). In doing so, the alert volume prediction compute device 120, in the illustrative embodiment, obtains data indicative of financial transactions that were the subject of alerts produced by one or more of the scenario detection models 132 and the dates associated with each of the financial transactions, as indicated in blocks 316 and 318. Further, and as indicated in block 320, the alert volume prediction compute device 120 obtains updated historical alert data, including the underlying historical financial transaction data 152 at the frequency of the highest-frequency scenario detection model 132 (e.g., on a weekly basis). As such, the alert volume prediction compute device 120 is updated at the rate that the models 132 are executed and/or updated, thereby enabling the alert volume prediction compute device 120 to readily account for any changes in the scenario detection models 132 and/or the banking system that may impact the number of alerts that will be produced by the scenario detection models 132 in the future.

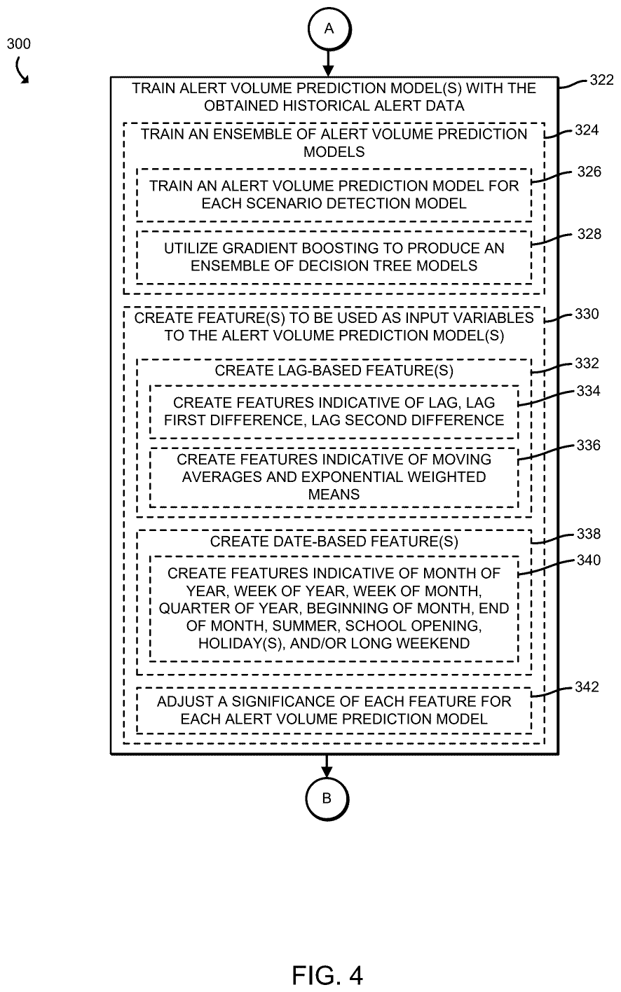

Referring now to FIG. 4, the method 300 continues to block 322 in which the alert volume prediction compute device 120, in the illustrative embodiment, trains the one or more alert volume prediction models 122 with the obtained historical alert data from block 302 of FIG. 3 (e.g., to predict the number of alerts that will be produced by the scenario detection models 132). As discussed above, the alert volume prediction compute device 120, in the illustrative embodiment, obtains the historical alert data at the frequency of the highest-frequency scenario detection model 132 (e.g., on a weekly basis) and, as such, performs the model training associated with block 322 at the same frequency (e.g., on a weekly basis). As indicated in block 324, the alert volume prediction compute device 120 may train an ensemble (e.g., a group) of alert volume prediction models. For example, the alert volume prediction compute device 120 may train an alert volume prediction model 122 for each scenario detection model 132 (e.g., with a one to one correspondence), as indicated in block 326. In the illustrative embodiment, the alert volume prediction compute device 120 utilizes gradient boosting to produce an ensemble of decision tree models (e.g., as the alert volume prediction models 122), as indicated in block 328. As compared to other architectures, prediction models produced with gradient boosting (e.g., a machine learning ensemble technique in which predictions of multiple weak learners such as decision trees are combined sequentially) demonstrate better performance (e.g., higher prediction accuracy) for tabular data (e.g., the training data may be formatted as tabular data, such as time-series forecasting data converted to a tabular dataset, wherein each row is an individual data point in a time series ordered by date, and each column is an individual variable that is created for that data point).

As indicated in block 330, the alert volume prediction compute device 120 may create one or more features to be used as inputs (e.g., input variables) to the alert volume prediction model(s) 122. In doing so, the alert volume prediction compute device 120 may create one or more lag-based features (e.g., features that shift values forward by one or more time steps in a set of time series data), as indicated in block 332. As indicated in block 334, the alert volume prediction compute device 120 may create features indicative of lag, lag first difference, and lag second difference. The differences indicate calculated changes between values in the time series data. The alert volume prediction compute device 120 may also create features indicative of moving averages and/or exponential weighted means, as indicated in block 336. Additionally or alternatively, the alert volume prediction compute device 120 may create date-based features, as indicated in block 338. In doing so, and as indicated in block 340, the alert volume prediction compute device 120 may create features indicative of the month of the year, the week of the year, the week of the month, the quarter of the year (e.g., first, second, third, fourth), the beginning of the month, the end of the month, summer, school opening, holidays, and/or a long weekend. That is, while the underlying data may indicate the date that a particular event occurred (e.g., a financial transaction, an alert, etc.), the features indicate information (e.g., exogenous information) about the significance of the date.

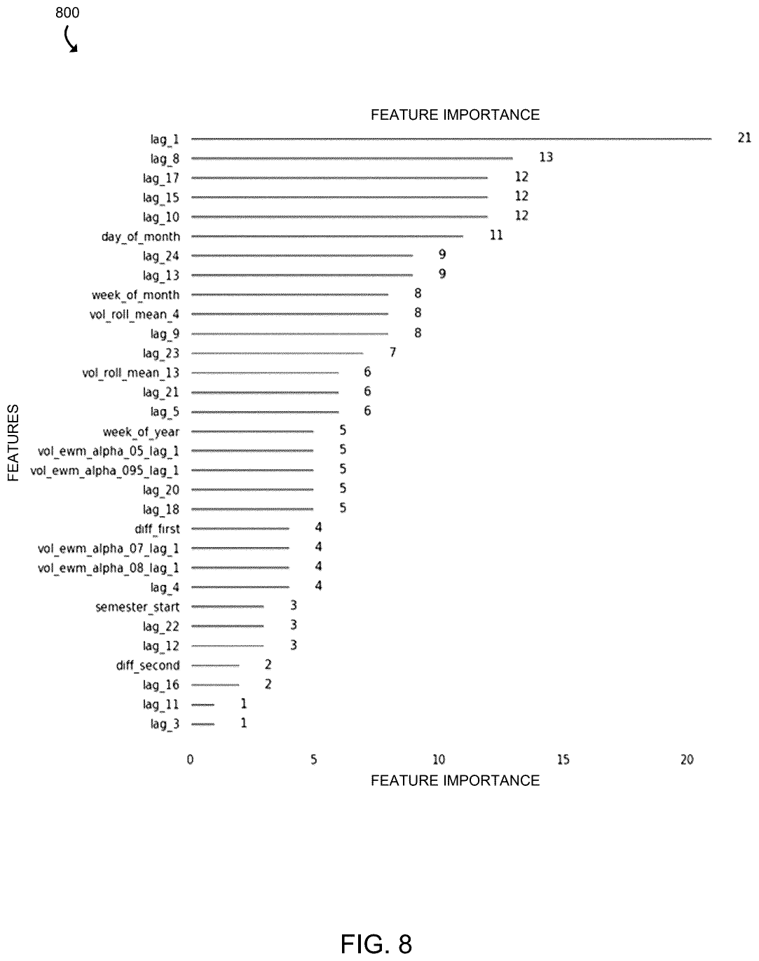

As some money laundering scenarios may experience cyclic changes in prevalence (e.g., seasonality) or may be dependent on factors in the banking system or external environment that change based on the time of year (e.g., presence of a holiday, proximity to the beginning or end of a month, etc.), features identifying the significance of certain dates may enable the alert volume prediction models to more accurately predict the alert volume associated with money laundering scenarios. The alert volume prediction compute device 120 may adjust the significance of each feature for each alert volume prediction model (e.g., to increase the prediction accuracy), as indicated in block 342. In some embodiments, the alert volume prediction compute device 120 adjusts the significance of the features through a grid search process (e.g., evaluating all combinations of sets of values, forming a grid of values). An embodiment of an allocation 800 of significance or importance that may be assigned to features for an alert volume prediction model 122 is represented in FIG. 8.

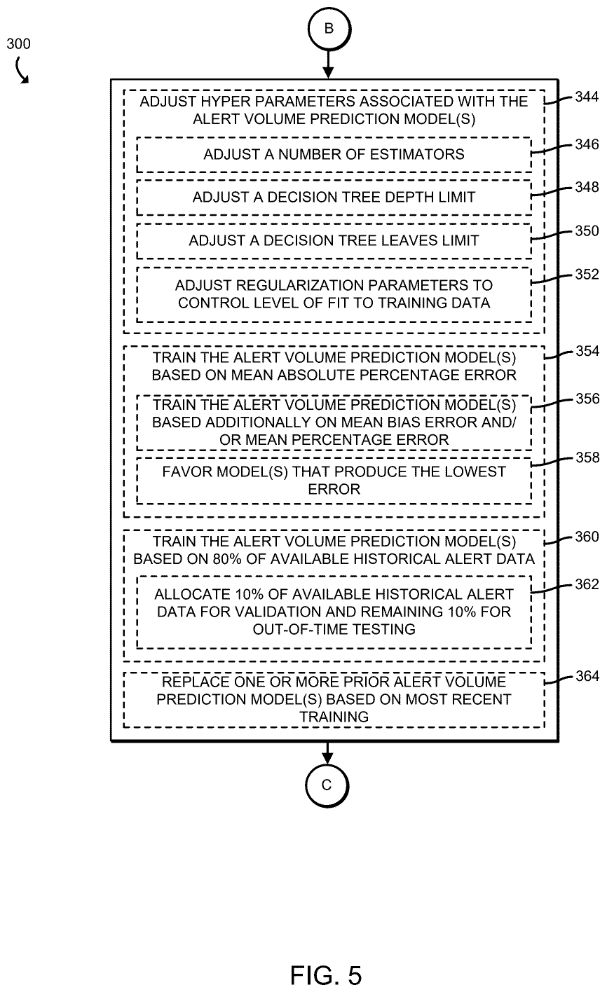

Referring now to FIG. 5, the alert volume prediction compute device 120 may adjust one or more hyper parameters associated with the alert volume prediction models 122, as indicated in block 344. In doing so, the alert volume prediction compute device 120 may adjust a number of estimators (e.g., decision trees) used in one or more of the models 122, as indicated in block 346. Additionally or alternatively, the alert volume prediction compute device 120 may adjust a depth limit for the decision trees in one or more of the models 122, as indicated in block 348. The alert volume prediction compute device 120 may also adjust a limit on the number of leaves (e.g., decision tree leaves) one or more of the alert volume prediction models 122 may have, as indicated in block 350. In some embodiments, the alert volume prediction compute device 120 may adjust one or more regularization parameters (e.g., alpha and lambda) to control the level of fit of one or more of the models 122 to the training data (e.g., the historical alert data), as indicated in block 352. That is, the alert volume prediction compute device 120 may prevent the models 122 from being over fit to the training data (e.g., a state in which a model has higher prediction accuracy for existing training data at the cost of lower prediction accuracy for another set of slightly different data). The alert volume prediction compute device 120 may set or adjust other hyper parameters as well (e.g., number of iterations, learning rate, etc.). The alert volume prediction compute device 120 may identify values for the hyper parameters that provide the best prediction accuracy, while avoiding overfitting, using a grid search process. Examples of values for the hyper parameters for a model 122 may be alpha: 0.1, lambda: 0.5, iterations: 100, learning rate: 0.1, maximum depth: 5.

As indicated in block 354, the alert volume prediction compute device 120 may train the alert volume prediction models 122 based on mean absolute percentage error (MAPE) (e.g., to reduce the MAPE associated with the models 122). Mean absolute percentage error is represented by Equation 1, shown below:

$$M A P E = \frac{1}{N} {\sum }_{i = 1}^{N} \vert \frac{Prediction - True Value}{True Value} \vert \qquad ( Equation 1 )$$

The alert volume prediction compute device 120 may also train the alert volume prediction models 122 based on mean bias error or mean percentage error. The equations for mean bias error and mean percentage error are provided below as Equations 2 and 3, respectively.

$$M B E = \frac{1}{N} {\sum }_{i = 1}^{N} ( True Value - Prediction ) \qquad ( Equation 2 )$$

$$M P E = \frac{1}{N} {\sum }_{i = 1}^{N} ( \frac{True Value - Prediction}{True Value} ) \qquad ( Equation 3 )$$

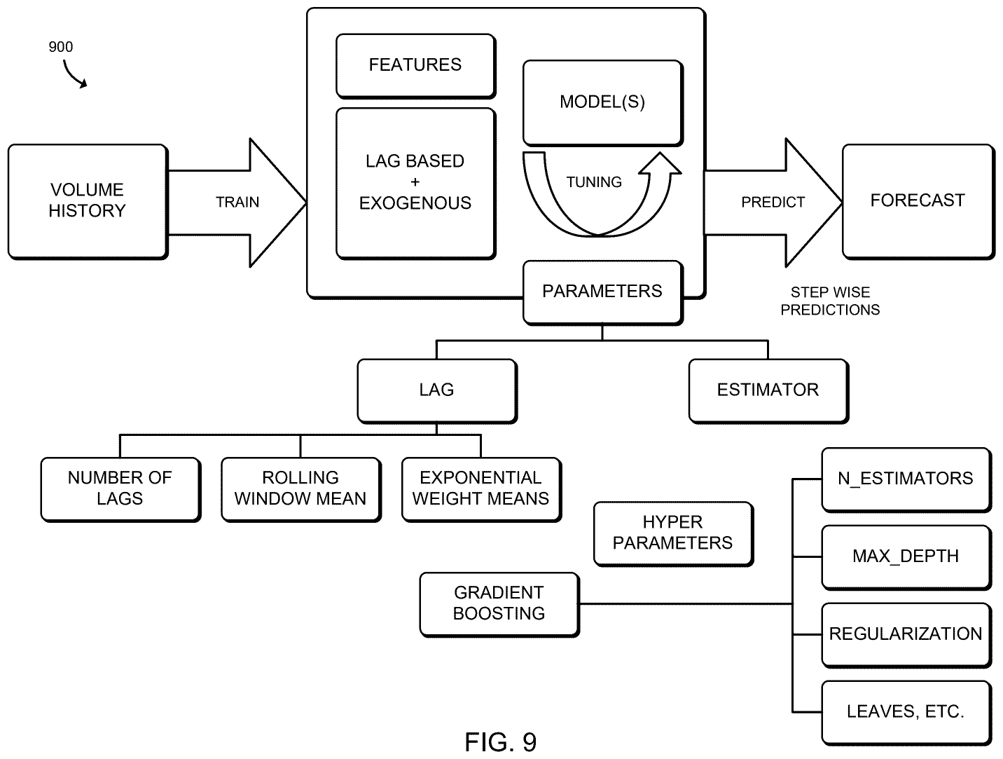

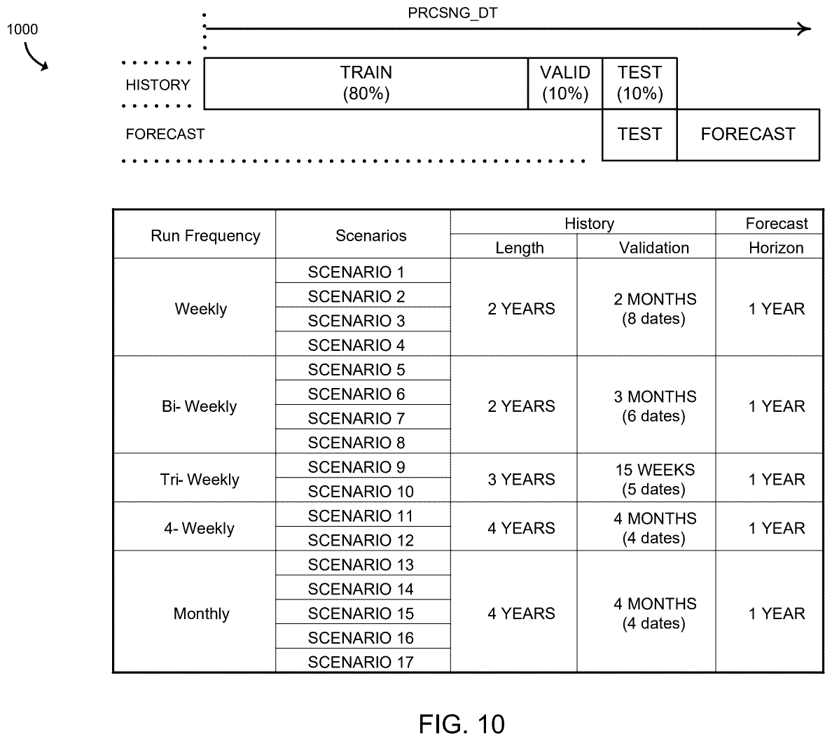

A high level diagram 900 focusing on the creation of features and adjustment of hyper parameters is provided in FIG. 9. In training, the alert volume prediction compute device 120 favors models that produce the lowest error (e.g., MAPE, mean bias error, or mean percentage error), as indicated in block 358. The alert volume prediction compute device 120, in the illustrative embodiment, may train the alert volume prediction models 122 based on a subset (e.g., 80%) of the available historical alert data, as indicated in block 360. Further, the alert volume prediction compute device 120 may allocate a portion of the remainder (e.g., 10%) of the historical alert data for validation, and the remaining amount (e.g., the remaining 10%) for out-of-time testing, as indicated in block 362. A diagram 1000 of an embodiment of an allocation of the historical alert data for training, validation, and out-of-time testing, to enable subsequent forecasting by the alert volume prediction models 122, and information regarding the execution frequency, historical timeline, and prediction (forecast) timeline is shown in FIG. 10. In the illustrative embodiment, the alert volume prediction compute device 120 retrains the models on a continual basis (e.g., weekly) and replaces the prior alert volume prediction models with the retrained versions, as indicated in block 364.

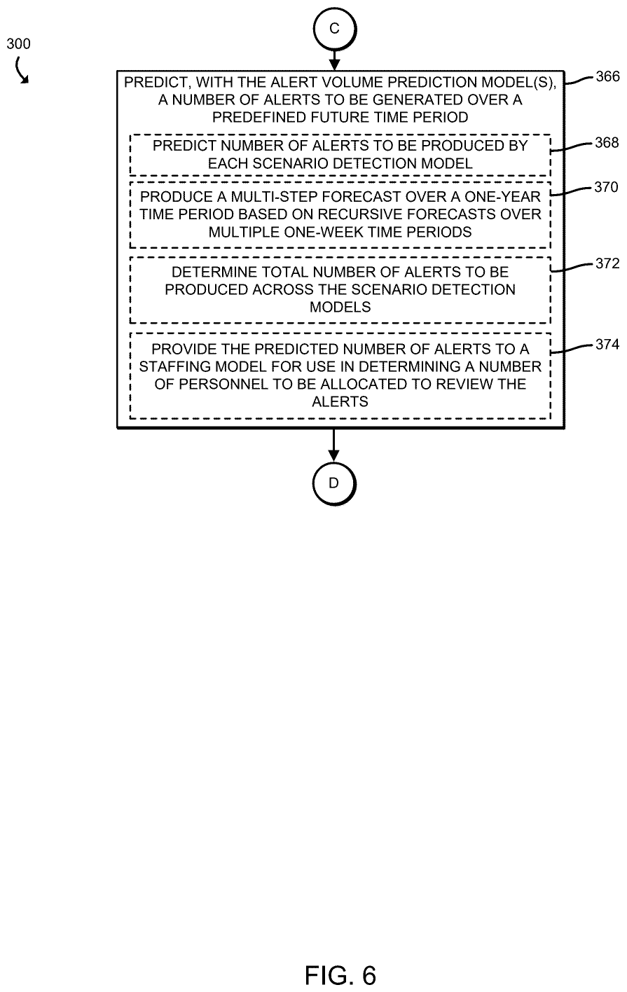

Referring now to FIG. 6, in block 366, the alert volume prediction compute device 120 may predict, with the alert volume prediction models 122 (e.g., after the training of block 322), a number of alerts to be generated over a predefined future period (e.g., twelve months). As indicated in block 368, the alert volume prediction compute device 120, in the illustrative embodiment, predicts the number of alerts that will be produced by each of the scenario detection models 132. In doing so, the alert volume prediction compute device 120 may produce the forecast (e.g., for a twelve month period) in multiple-steps, based on recursive forecasts over multiple one-week time periods, as indicated in block 370. The alert volume prediction compute device 120 may determine the total number of alerts to be produced across the scenario detection models (e.g., by adding together the alert volume predictions associated with each scenario), as indicated in block 372. Further, the alert volume prediction compute device 120 may provide the predicted number of alerts (e.g., from block 372) to a staffing model (e.g., the personnel allocation model 142 via communication with the personnel allocation compute device 140) for use in determining a number of personnel to be allocated to review the alerts (e.g., on a week-by-week basis). Afterwards, the method 300, in the illustrative embodiment, loops back to block 302 to perform a subsequent iteration of obtaining historical alert data, retraining of the models 122, and producing another prediction of alert volumes. Though the operations of the method 300 are described in a particular sequence, it should be understood that in other embodiments, operations may be performed in a different order and/or in parallel.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain historical alert data indicative of alerts produced by each of multiple money laundering scenario detection models associated with deposit accounts; train, prior to producing a prediction, at least one alert volume prediction model with the obtained historical alert data; and predict, with the at least one alert volume prediction model, a number of alerts to be generated by the money laundering scenario detection models over a future time period.

Example 2 includes the subject matter of Example 1, and wherein the circuitry is further configured to retrain, based on subsequent historical alert data, the at least one alert volume prediction model prior to producing a subsequent prediction of a number of alerts to be generated by the money laundering scenario detection models.

Example 3 includes the subject matter of any of Examples 1 and 2, and wherein the circuitry is further configured to retrain the at least one alert volume prediction model on a weekly basis.

Example 4 includes the subject matter of any of Examples 1-3, and wherein to obtain historical alert data comprises to obtain historical alert data indicative of alerts produced by multiple money laundering scenario detection models for detecting different money laundering scenarios.

Example 5 includes the subject matter of any of Examples 1-4, and wherein to obtain historical alert data comprises to obtain historical alert data indicative of alerts produced by money laundering scenario detection models that utilize different lookback periods.

Example 6 includes the subject matter of any of Examples 1-5, and wherein to obtain historical alert data comprises to obtain historical alert data indicative of alerts produced by money laundering scenario detection models executed at different frequencies.

Example 7 includes the subject matter of any of Examples 1-6, and wherein to obtain historical alert data comprises to obtain historical alert data indicative of alerts produced by money laundering scenario detection models that utilize different input variables or features based on historical financial transaction data.

Example 8 includes the subject matter of any of Examples 1-7, and wherein to obtain historical alert data comprises to obtain historical alert data indicative of alerts produced by money laundering scenario detection models for financial transactions over a continuous set of dates over a historical time period.

Example 9 includes the subject matter of any of Examples 1-8, and wherein the circuitry is further to obtain historical financial transaction data indicative of financial transactions performed in association with the deposit accounts.

Example 10 includes the subject matter of any of Examples 1-9, and wherein to obtain historical financial transaction data comprises to obtain data indicative of financial transactions that were the subject of alerts produced by one or more of the money laundering scenario detection models.

Example 11 includes the subject matter of any of Examples 1-10, and wherein the circuitry is further configured to obtain data indicative of the date of each financial transaction that was the subject of an alert.

Example 12 includes the subject matter of any of Examples 1-11, and wherein to train at least one alert volume prediction model comprises to train an ensemble of alert volume prediction models.

Example 13 includes the subject matter of any of Examples 1-12, and wherein to train an ensemble of alert volume prediction models comprises to train an alert volume prediction model for each money laundering scenario detection model.

Example 14 includes the subject matter of any of Examples 1-13, and wherein to train an ensemble of alert volume prediction models comprises to utilize gradient boosting to produce the ensemble of decision tree models as the alert volume prediction models.

Example 15 includes the subject matter of any of Examples 1-14, and wherein to train at least one alert volume prediction model comprises to create features to be used as input variables to the at least one alert volume prediction model.

Example 16 includes the subject matter of any of Examples 1-15, and wherein to create features comprises to create lag-based features and date-based features.

Example 17 includes the subject matter of any of Examples 1-16, and wherein to create lag-based features comprises to create features indicative of a lag, a lag first difference, a lag second difference, a moving average, and an exponential weighted mean.

Example 18 includes the subject matter of any of Examples 1-17, and wherein to create date-based features comprises to create features indicative of a month of a year, a week of a year, a week of a month, a quarter of a year, a beginning of a month, an end of a month, summer, a school opening, one or more holidays, and a long weekend.

Example 19 includes the subject matter of any of Examples 1-18, and wherein the circuitry is further configured to adjust a significance of each feature for each of multiple alert volume prediction models, wherein each alert volume prediction model is associated with a corresponding money laundering scenario detection model.

Example 20 includes the subject matter of any of Examples 1-19, and wherein to train at least one alert volume prediction model comprises to adjust one or more hyper parameters associated with the at least one alert volume prediction model.

Example 21 includes the subject matter of any of Examples 1-20, and wherein to adjust one or more hyper parameters comprises to adjust a number of estimators.

Example 22 includes the subject matter of any of Examples 1-21, and wherein to adjust one or more hyper parameters comprises to adjust a decision tree depth limit.

Example 23 includes the subject matter of any of Examples 1-22, and wherein to adjust one or more hyper parameters comprises to adjust a limit for a number of leaves in a decision tree.

Example 24 includes the subject matter of any of Examples 1-23, and wherein to adjust one or more hyper parameters comprises to adjust one or more regularization parameters to control a level of fit to training data.

Example 25 includes the subject matter of any of Examples 1-24, and wherein to adjust one or more hyper parameters comprises to adjust one or more hyper parameters for multiple alert volume prediction models in an ensemble.

Example 26 includes the subject matter of any of Examples 1-25, and wherein to train the at least one alert volume prediction model comprises to train the at least one alert volume prediction model based on mean absolute percentage error.

Example 27 includes the subject matter of any of Examples 1-26, and wherein the circuitry is further configured to train the at least one alert volume prediction model based additionally on a mean bias error or a mean percentage error.

Example 28 includes the subject matter of any of Examples 1-27, and wherein to train the at least one alert volume prediction model comprises to train the at least one alert volume prediction model based on 80% of the historical alert data and allocate a remainder of the historical alert data to validation and out-of-time testing.

Example 29 includes the subject matter of any of Examples 1-28, and wherein to train the at least one alert volume prediction model comprises to replace a prior alert volume prediction model.

Example 30 includes the subject matter of any of Examples 1-29, and wherein to predict the number of alerts comprises to predict a number of alerts to be produced by each scenario detection model; and determine a total number of alerts to be produced across the scenario detection models.

Example 31 includes the subject matter of any of Examples 1-30, and wherein to predict the number of alerts comprises to produce a multi-step forecast over a one-year time period based on recursive forecasts over multiple one-week time periods.

Example 32 includes the subject matter of any of Examples 1-31, and wherein to predict the number of alerts comprises to provide the predicted number of alerts to a staffing model for use in determining a number of personnel to be allocated to review the alerts.

Example 33 includes a method comprising obtaining, by a compute device, historical alert data indicative of alerts produced by each of multiple money laundering scenario detection models associated with deposit accounts; training, by the compute device and prior to producing a prediction, at least one alert volume prediction model with the obtained historical alert data; and predicting, by the compute device and with the at least one alert volume prediction model, a number of alerts to be generated by the money laundering scenario detection models over a future time period.

Example 34 includes the subject matter of Example 33, and further including retraining, by the compute device and based on subsequent historical alert data, the at least one alert volume prediction model prior to producing a subsequent prediction of a number of alerts to be generated by the money laundering scenario detection models.

Example 35 includes the subject matter of any of Examples 33 and 34, and further including retraining, by the compute device, the at least one alert volume prediction model on a weekly basis.

Example 36 includes the subject matter of any of Examples 33-35, and wherein obtaining historical alert data comprises obtaining historical alert data indicative of alerts produced by multiple money laundering scenario detection models for detecting different money laundering scenarios.

Example 37 includes the subject matter of any of Examples 33-36, and wherein obtaining historical alert data comprises obtaining historical alert data indicative of alerts produced by money laundering scenario detection models that utilize different lookback periods.

Example 38 includes the subject matter of any of Examples 33-37, and wherein obtaining historical alert data comprises obtaining historical alert data indicative of alerts produced by money laundering scenario detection models executed at different frequencies.

Example 39 includes the subject matter of any of Examples 33-38, and wherein obtaining historical alert data comprises obtaining historical alert data indicative of alerts produced by money laundering scenario detection models that utilize different input variables or features based on historical financial transaction data.

Example 40 includes the subject matter of any of Examples 33-39, and wherein obtaining historical alert data comprises obtaining historical alert data indicative of alerts produced by money laundering scenario detection models for financial transactions over a continuous set of dates over a historical time period.

Example 41 includes the subject matter of any of Examples 33-40, and further including obtaining, by the compute device, historical financial transaction data indicative of financial transactions performed in association with the deposit accounts.

Example 42 includes the subject matter of any of Examples 33-41, and wherein obtaining historical financial transaction data comprises obtaining data indicative of financial transactions that were the subject of alerts produced by one or more of the money laundering scenario detection models.

Example 43 includes the subject matter of any of Examples 33-42, and further including obtaining, by the compute device, data indicative of the date of each financial transaction that was the subject of an alert.

Example 44 includes the subject matter of any of Examples 33-43, and wherein training at least one alert volume prediction model comprises training an ensemble of alert volume prediction models.

Example 45 includes the subject matter of any of Examples 33-44, and wherein training an ensemble of alert volume prediction models comprises training an alert volume prediction model for each money laundering scenario detection model.

Example 46 includes the subject matter of any of Examples 33-45, and wherein training an ensemble of alert volume prediction models comprises utilizing gradient boosting to produce the ensemble of decision tree models as the alert volume prediction models.

Example 47 includes the subject matter of any of Examples 33-46, and wherein training at least one alert volume prediction model comprises creating features to be used as input variables to the at least one alert volume prediction model.

Example 48 includes the subject matter of any of Examples 33-47, and wherein creating features comprises creating lag-based features and date-based features.

Example 49 includes the subject matter of any of Examples 33-48, and wherein creating lag-based features comprises creating features indicative of a lag, a lag first difference, a lag second difference, a moving average, and an exponential weighted mean.

Example 50 includes the subject matter of any of Examples 33-49, and wherein creating date-based features comprises creating features indicative of a month of a year, a week of a year, a week of a month, a quarter of a year, a beginning of a month, an end of a month, summer, a school opening, one or more holidays, and a long weekend.

Example 51 includes the subject matter of any of Examples 33-50, and further including adjusting, by the compute device, a significance of each feature for each of multiple alert volume prediction models, wherein each alert volume prediction model is associated with a corresponding money laundering scenario detection model.

Example 52 includes the subject matter of any of Examples 33-51, and wherein training at least one alert volume prediction model comprises adjusting one or more hyper parameters associated with the at least one alert volume prediction model.

Example 53 includes the subject matter of any of Examples 33-52, and wherein adjusting one or more hyper parameters comprises adjusting a number of estimators.

Example 54 includes the subject matter of any of Examples 33-53, and wherein adjusting one or more hyper parameters comprises adjusting a decision tree depth limit.

Example 55 includes the subject matter of any of Examples 33-54, and wherein adjusting one or more hyper parameters comprises adjusting a limit for a number of leaves in a decision tree.

Example 56 includes the subject matter of any of Examples 33-55, and wherein adjusting one or more hyper parameters comprises adjusting one or more regularization parameters to control a level of fit to training data.

Example 57 includes the subject matter of any of Examples 33-56, and wherein adjusting one or more hyper parameters comprises adjusting one or more hyper parameters for multiple alert volume prediction models in an ensemble.

Example 58 includes the subject matter of any of Examples 33-57, and wherein training the at least one alert volume prediction model comprises training the at least one alert volume prediction model based on mean absolute percentage error.

Example 59 includes the subject matter of any of Examples 33-58, and further including training, by the compute device, the at least one alert volume prediction model based additionally on a mean bias error or a mean percentage error.

Example 60 includes the subject matter of any of Examples 33-59, and wherein training the at least one alert volume prediction model comprises training the at least one alert volume prediction model based on 80% of the historical alert data and allocating a remainder of the historical alert data to validation and out-of-time testing.

Example 61 includes the subject matter of any of Examples 33-60, and wherein training the at least one alert volume prediction model comprises replacing a prior alert volume prediction model.

Example 62 includes the subject matter of any of Examples 33-61, and wherein predicting the number of alerts comprises predicting a number of alerts to be produced by each scenario detection model; and determining a total number of alerts to be produced across the scenario detection models.

Example 63 includes the subject matter of any of Examples 33-62, and wherein predicting the number of alerts comprises producing a multi-step forecast over a one-year time period based on recursive forecasts over multiple one-week time periods.

Example 64 includes the subject matter of any of Examples 33-63, and wherein predicting the number of alerts comprises providing the predicted number of alerts to a staffing model for use in determining a number of personnel to be allocated to review the alerts.

Example 65 includes one or more machine-readable storage media comprising a plurality of instructions stored thereon that, in response to being executed, cause a compute device to obtain historical alert data indicative of alerts produced by each of multiple money laundering scenario detection models associated with deposit accounts; train, prior to producing a prediction, at least one alert volume prediction model with the obtained historical alert data; and predict, with the at least one alert volume prediction model, a number of alerts to be generated by the money laundering scenario detection models over a future time period.

Example 66 includes the subject matter of Example 65, and wherein the one or more instructions additionally cause the compute device to retrain, based on subsequent historical alert data, the at least one alert volume prediction model prior to producing a subsequent prediction of a number of alerts to be generated by the money laundering scenario detection models.

Example 67 includes the subject matter of any of Examples 65 and 66, and wherein the one or more instructions additionally cause the compute device to retrain the at least one alert volume prediction model on a weekly basis.

Example 68 includes the subject matter of any of Examples 65-67, and wherein to obtain historical alert data comprises to obtain historical alert data indicative of alerts produced by multiple money laundering scenario detection models for detecting different money laundering scenarios.

Example 69 includes the subject matter of any of Examples 65-68, and wherein to obtain historical alert data comprises to obtain historical alert data indicative of alerts produced by money laundering scenario detection models that utilize different lookback periods.

Example 70 includes the subject matter of any of Examples 65-69, and wherein to obtain historical alert data comprises to obtain historical alert data indicative of alerts produced by money laundering scenario detection models executed at different frequencies.

Example 71 includes the subject matter of any of Examples 65-70, and wherein to obtain historical alert data comprises to obtain historical alert data indicative of alerts produced by money laundering scenario detection models that utilize different input variables or features based on historical financial transaction data.

Example 72 includes the subject matter of any of Examples 65-71, and wherein to obtain historical alert data comprises to obtain historical alert data indicative of alerts produced by money laundering scenario detection models for financial transactions over a continuous set of dates over a historical time period.

Example 73 includes the subject matter of any of Examples 65-72, and wherein the one or more instructions additionally cause the compute device to obtain historical financial transaction data indicative of financial transactions performed in association with the deposit accounts.

Example 74 includes the subject matter of any of Examples 65-73, and wherein to obtain historical financial transaction data comprises to obtain data indicative of financial transactions that were the subject of alerts produced by one or more of the money laundering scenario detection models.

Example 75 includes the subject matter of any of Examples 65-74, and wherein the one or more instructions additionally cause the compute device to obtain data indicative of the date of each financial transaction that was the subject of an alert.

Example 76 includes the subject matter of any of Examples 65-75, and wherein to train at least one alert volume prediction model comprises to train an ensemble of alert volume prediction models.

Example 77 includes the subject matter of any of Examples 65-76, and wherein to train an ensemble of alert volume prediction models comprises to train an alert volume prediction model for each money laundering scenario detection model.

Example 78 includes the subject matter of any of Examples 65-77, and wherein to train an ensemble of alert volume prediction models comprises to utilize gradient boosting to produce the ensemble of decision tree models as the alert volume prediction models.

Example 79 includes the subject matter of any of Examples 65-78, and wherein to train at least one alert volume prediction model comprises to create features to be used as input variables to the at least one alert volume prediction model.

Example 80 includes the subject matter of any of Examples 65-79, and wherein to create features comprises to create lag-based features and date-based features.

Example 81 includes the subject matter of any of Examples 65-80, and wherein to create lag-based features comprises to create features indicative of a lag, a lag first difference, a lag second difference, a moving average, and an exponential weighted mean.

Example 82 includes the subject matter of any of Examples 65-81, and wherein to create date-based features comprises create features indicative of a month of a year, a week of a year, a week of a month, a quarter of a year, a beginning of a month, an end of a month, summer, a school opening, one or more holidays, and a long weekend.

Example 83 includes the subject matter of any of Examples 65-82, and wherein the one or more instructions additionally cause the compute device to adjust a significance of each feature for each of multiple alert volume prediction models, wherein each alert volume prediction model is associated with a corresponding money laundering scenario detection model.

Example 84 includes the subject matter of any of Examples 65-83, and wherein to train at least one alert volume prediction model comprises to adjust one or more hyper parameters associated with the at least one alert volume prediction model.

Example 85 includes the subject matter of any of Examples 65-84, and wherein to adjust one or more hyper parameters comprises to adjust a number of estimators.

Example 86 includes the subject matter of any of Examples 65-85, and wherein to adjust one or more hyper parameters comprises to adjust a decision tree depth limit.

Example 87 includes the subject matter of any of Examples 65-86, and wherein to adjust one or more hyper parameters comprises to adjust a limit for a number of leaves in a decision tree.

Example 88 includes the subject matter of any of Examples 65-87, and wherein to adjust one or more hyper parameters comprises to adjust one or more regularization parameters to control a level of fit to training data.

Example 89 includes the subject matter of any of Examples 65-88, and wherein to adjust one or more hyper parameters comprises to adjust one or more hyper parameters for multiple alert volume prediction models in an ensemble.

Example 90 includes the subject matter of any of Examples 65-89, and wherein to train the at least one alert volume prediction model comprises to train the at least one alert volume prediction model based on mean absolute percentage error.

Example 91 includes the subject matter of any of Examples 65-90, and wherein the one or more instructions additionally cause the compute device to train the at least one alert volume prediction model based additionally on a mean bias error or a mean percentage error.

Example 92 includes the subject matter of any of Examples 65-91, and wherein to train the at least one alert volume prediction model comprises to train the at least one alert volume prediction model based on 80% of the historical alert data and allocate a remainder of the historical alert data to validation and out-of-time testing.

Example 93 includes the subject matter of any of Examples 65-92, and wherein to train the at least one alert volume prediction model comprises to replace a prior alert volume prediction model.

Example 94 includes the subject matter of any of Examples 65-93, and wherein to predict the number of alerts comprises to predict a number of alerts to be produced by each scenario detection model; and determine a total number of alerts to be produced across the scenario detection models.

Example 95 includes the subject matter of any of Examples 65-94, and wherein to predict the number of alerts comprises to produce a multi-step forecast over a one-year time period based on recursive forecasts over multiple one-week time periods.

Example 96 includes the subject matter of any of Examples 65-95, and wherein to predict the number of alerts comprises to provide the predicted number of alerts to a staffing model for use in determining a number of personnel to be allocated to review the alerts.

1. A compute device comprising:
circuitry configured to:
obtain historical alert data indicative of alerts produced by each of multiple money laundering scenario detection models associated with deposit accounts;
train, prior to producing a prediction, at least one alert volume prediction model with the obtained historical alert data; and
predict, with the at least one alert volume prediction model, a number of alerts to be generated by the money laundering scenario detection models over a future time period.

2. The compute device of claim 1, wherein the circuitry is further configured to retrain, based on subsequent historical alert data, the at least one alert volume prediction model prior to producing a subsequent prediction of a number of alerts to be generated by the money laundering scenario detection models.

3. The compute device of claim 1, wherein the circuitry is further configured to retrain the at least one alert volume prediction model on a weekly basis.

4. The compute device of claim 1, wherein to train at least one alert volume prediction model comprises to train an ensemble of alert volume prediction models comprises (i) training an alert volume prediction model for each money laundering scenario detection model; and/or (ii) utilizing gradient boosting to produce the ensemble of decision tree models as the alert volume prediction models.

5. The compute device of claim 1, wherein to train at least one alert volume prediction model comprises to create features to be used as input variables to the at least one alert volume prediction model.

6. The compute device of claim 5, wherein to create features comprises to create lag-based features and date-based features by (i) creating features indicative of a lag, a lag first difference, a lag second difference, a moving average, and an exponential weighted mean; and/or (ii) creating features indicative of a month of a year, a week of a year, a week of a month, a quarter of a year, a beginning of a month, an end of a month, summer, a school opening, one or more holidays, and a long weekend.

7. The compute device of claim 6, wherein the circuitry is further configured to adjust a significance of each feature for each of multiple alert volume prediction models, wherein each alert volume prediction model is associated with a corresponding money laundering scenario detection model.

8. The compute device of claim 1, wherein to train at least one alert volume prediction model comprises to adjust one or more hyper parameters associated with the at least one alert volume prediction model.

9. The compute device of claim 8, wherein to adjust one or more hyper parameters comprises to adjust: (i) a number of estimators; (ii) a decision tree depth limit; (iii) a number of leaves in a decision tree; (iv) one or more regularization parameters to control a level of fit to training data; and/or (v) one or more hyper parameters for multiple alert volume prediction models in an ensemble.

10. The compute device of claim 1, wherein to train the at least one alert volume prediction model comprises to train the at least one alert volume prediction model based on mean absolute percentage error.

11. The compute device of claim 1, wherein to train the at least one alert volume prediction model comprises to train the at least one alert volume prediction model based on 80% of the historical alert data and allocate a remainder of the historical alert data to validation and out-of-time testing.

12. The compute device of claim 1, wherein to predict the number of alerts comprises to:
predict a number of alerts to be produced by each scenario detection model; and
determine a total number of alerts to be produced across the scenario detection models.

13. The compute device of claim 1, wherein to predict the number of alerts comprises (i) to produce a multi-step forecast over a one-year time period based on recursive forecasts over multiple one-week time periods; and/or (ii) to provide the predicted number of alerts to a staffing model for use in determining a number of personnel to be allocated to review the alerts.

14. A method comprising:
obtaining, by a compute device, historical alert data indicative of alerts produced by each of multiple money laundering scenario detection models associated with deposit accounts;
training, by the compute device and prior to producing a prediction, at least one alert volume prediction model with the obtained historical alert data; and
predicting, by the compute device and with the at least one alert volume prediction model, a number of alerts to be generated by the money laundering scenario detection models over a future time period.

15. The method of claim 14, further comprising retraining, by the compute device, based on subsequent historical alert data, the at least one alert volume prediction model prior to producing a subsequent prediction of a number of alerts to be generated by the money laundering scenario detection models.

16. The method of claim 15, further comprising retraining the at least one alert volume prediction model on a weekly basis.

17. The method of claim 15, wherein training at least one alert volume prediction model comprises training an ensemble of alert volume prediction models by: (i) training an alert volume prediction model for each money laundering scenario detection model; and/or (ii) utilizing gradient boosting to produce the ensemble of decision tree models as the alert volume prediction models.

18. The method of claim 15, wherein training at least one alert volume prediction model comprises creating features to be used as input variables to the at least one alert volume prediction model.

19. The method of claim 18, wherein creating features comprises creating lag-based features and date-based features by: (i) creating features indicative of a lag, a lag first difference, a lag second difference, a moving average, and an exponential weighted mean; and/or (ii) creating features indicative of a month of a year, a week of a year, a week of a month, a quarter of a year, a beginning of a month, an end of a month, summer, a school opening, one or more holidays, and a long weekend.

20. The method of claim 19, further comprising adjusting a significance of each feature for each of multiple alert volume prediction models, wherein each alert volume prediction model is associated with a corresponding money laundering scenario detection model.

21. The method of claim 14, wherein training at least one alert volume prediction model comprises adjusting one or more hyper parameters associated with the at least one alert volume prediction model.

22. The method of claim 21, wherein adjusting one or more hyper parameters comprises adjusting: (i) a number of estimators; (ii) a decision tree depth limit; (iii) a number of leaves in a decision tree; (iv) one or more regularization parameters to control a level of fit to training data; and/or (v) one or more hyper parameters for multiple alert volume prediction models in an ensemble.

23. The method of claim 14, wherein training the at least one alert volume prediction model comprises training the at least one alert volume prediction model based on mean absolute percentage error.

24. The method of claim 14, wherein training the at least one alert volume prediction model comprises training the at least one alert volume prediction model based on 80% of the historical alert data and allocate a remainder of the historical alert data to validation and out-of-time testing.

25. The method of claim 14, wherein predicting the number of alerts comprises:
predicting a number of alerts to be produced by each scenario detection model; and
determining a total number of alerts to be produced across the scenario detection models.

26. The method of claim 14, wherein predicting the number of alerts comprises: (i) producing a multi-step forecast over a one-year time period based on recursive forecasts over multiple one-week time periods; and/or (ii) providing the predicted number of alerts to a staffing model for use in determining a number of personnel to be allocated to review the alerts.
